(19) United States
(12) Patent Application Publication
(10) Pub. No.: US 2006/0251832 A1
(43) Pub. Date: Nov. 9, 2006

(54) Photo medium composition

(76) Inventors: Bor-Jiunn Niu, San Diego, CA (US); Stefan Schuttel, Murten (CH)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/121,240

(22) Filed: May 3, 2005

(51) Int. Cl. B41M 5/00

(52) U.S. Cl. 428/32.34

(57) ABSTRACT

A photo medium composition is disclosed. The composition includes an adhesion promoting layer and at least two ink-receiving layers established on the adhesion promoting layer. Each of the ink-receiving layers has a polymeric binder composition including at least one of polyvinyl alcohol and modified polyvinyl alcohol, and at least one of styrene-acrylic copolymers and gelatin. An image enhancing layer, having cationic polyurethanes therein, is established on the at least two ink-receiving layers.

### BACKGROUND

The present disclosure relates generally to photo media, and more particularly to a multi-layer photo medium composition.

Inkjet print media may include one or more ink-receiving layers. Ink-receiving layers may have binder compositions made up of swellable materials, such as gelatin and other hydrogels such as polyvinylpyrrolidone and polyvinyl alcohol, which are commonly used for inkjet photo-imaging. These media may generally, in some instances, provide better lightfastness, air fading resistance, durability and image quality than porous ink receiving media. However, certain swellable materials may cause the ink-receiving layers to have relatively slow drying times, which may, in some instances, result in image transfer and potentially ruined images.

Some ink-receiving layers include cellulose binders. The combination of swellable materials and cellulose binders in an ink-receiving layer may, in some instances, result in relatively poor black haze, relatively poor gloss uniformity, curling of the medium, relatively poor color gamut, relatively poor image distinctness, and/or poor feed reliability. Still further, an image printed on such ink-receiving layers may stick to plastic album sheets or frames if a user does not allow for sufficient drying time.

As such, it would be desirable to provide an ink-receiving layer that substantially improves the quality of the printed image, the feed reliability of the media, and the drying time of the printed image.

### SUMMARY

A photo medium composition is disclosed. The composition includes an adhesion promoting layer, at least two ink-receiving layers established on the adhesion promoting layer, and an image enhancing layer established on the at least two ink-receiving layers. Each of the two ink-receiving layers has a polymeric binder composition including at least one of polyvinyl alcohol and modified polyvinyl alcohol, and including at least one of styrene-acrylic copolymers and gelatin. The image enhancing layer includes cationic polyurethanes.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1A is a schematic side view of an embodiment of a substrate and an optional coating thereon;

FIG. 1B is a schematic side view of an embodiment of the substrate having an adhesion promoting layer thereon;

FIG. 1C is a schematic side view of an embodiment of the substrate having the adhesion layer and a first ink-receiving layer thereon;

FIG. 1D is a schematic side view of an embodiment of the substrate having the adhesion layer, the first ink-receiving layer, and a second ink-receiving layer thereon; and

FIG. 1E is a schematic side view of an embodiment of a photo medium system.

### DETAILED DESCRIPTION

Embodiments of the photo medium composition and system as described hereinbelow may advantageously provide rapid drying times and high quality printed images. Without being bound to any theory, it is believed that this is due in part to the addition of cationic polyurethanes to an ink-receiving layer. Embodiment(s) of the photo medium composition and system may advantageously be used in a variety of applications, including, but not limited to printing systems that employ thermal inkjet technology.

It is to be understood that the terms “disposed on”, “deposited on”, “established on” and the like are broadly defined herein to encompass a variety of divergent layering arrangements and assembly techniques. These arrangements and techniques include, but are not limited to (1) the direct attachment of one material layer to another material layer with no intervening material layers therebetween; and (2) the attachment of one material layer to another material layer with one or more material layers therebetween provided that the one layer being “disposed on”, “deposited on”, or “established on” the other layer is somehow “supported” by the other layer (notwithstanding the presence of one or more additional material layers therebetween). The phrases “directly deposited on”, “deposited directly on”, “established directly on” and the like are broadly defined herein to encompass a situation(s) wherein a given material layer is secured to another material layer without any intervening material layers therebetween. Any statement used herein which indicates that one layer of material is on another layer is to be understood as involving a situation wherein the particular layer that is “on” the other layer in question is the outermost of the two layers relative to incoming ink materials being delivered by the printing system of interest. It is to be understood that the characterizations recited above are to be effective regardless of the orientation of the photo medium materials under consideration.

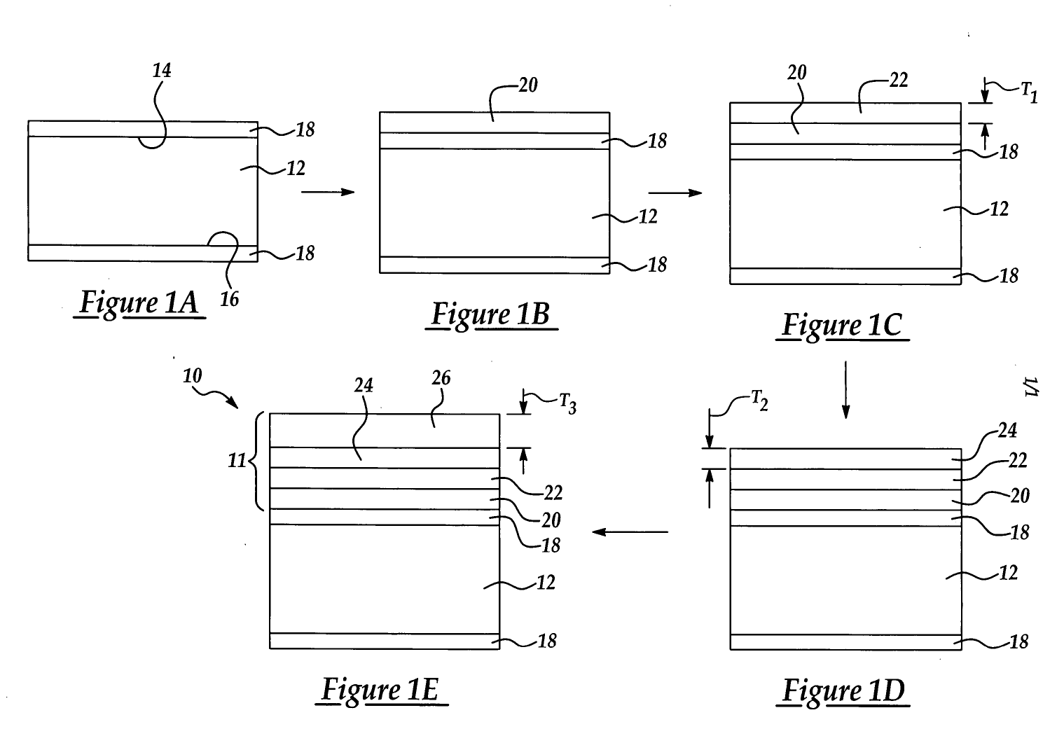

FIGS. 1A through 1E together illustrate an embodiment of a method of making an embodiment of a photo medium system 10 (shown in FIG. 1E).

FIG. 1A depicts a substrate 12. In an embodiment, the substrate 12 is photopaper. However, it is to be understood that many different materials may be employed in connection with the substrate 12 including, but not limited to those made from paper, polymeric materials (non-limitative examples of which include polyester white film or polyester transparent film), photopaper (non-limitative examples of which include polyethylene or polypropylene extruded on one or both sides of paper), metals, and/or mixtures thereof. A non-limitative example of a suitable metal material is a metal in foil form made from, for example, at least one of aluminum, silver, tin, copper, alloys thereof, and/or mixtures thereof. Furthermore, the substrate 12 may include an upper surface 14 and a lower surface 16 upon which various layers (such as those described herein) may be established. In an embodiment, the substrate 12 has a thickness along substantially the entire length ranging between about 0.025 mm and about 0.5 mm.

The substrate 12 may optionally be laminated/extruded with an ink-impermeable coating layer 18. One non-limitative example of a suitable ink-impermeable coating layer includes polyethylene. It is further contemplated that one or both surfaces 14, 16 of the substrate 12 may be coated with the ink-impermeable coating layer 18.

Embodiments of the photo medium system 10 include an embodiment(s) of the photo medium composition 11 (as shown in FIG. 1E) established on the substrate 12. The photo medium composition 11 includes an adhesion promoting layer 20, at least two ink-receiving layers, and an image enhancing layer established thereon. It is to be understood that each of the ink-receiving layers may have a substantially different or the same binder composition from an other of the ink-receiving layers.

An embodiment of a method of making the photo medium system 10 includes establishing the adhesion promoting layer 20 on one of the surfaces 14, 16 of the substrate 12 or on the optional coating layer 18, as shown in FIG. 1B. Any suitable deposition technique/manufacturing process may be used to establish the adhesion promoting layer 20 (and any subsequently established layers) on the substrate 12. Some non-limitative examples of suitable deposition techniques/manufacturing processes include roll-coating, conventional slot-die processing, blade coating, slot-die cascade coating, curtain coating and/or other comparable methods including those that use circulating and non-circulating coating technologies. In certain instances, spray-coating, immersion-coating, and/or cast-coating techniques may be suitable for establishing part of the composition 11, but not the full multilayer assembly.

Generally, the adhesion promoting layer 20 serves to substantially enhance the adhesion between the substrate 12 and any subsequently established layers. In an embodiment, the adhesion promoting layer 20 includes gelatin and polyvinyl alcohol. The adhesion promoting layer 20 may also include polyurethanes, cellulose, and combinations thereof. In an embodiment, the polyurethanes may be present in an amount ranging between about 10 dry weight % and about 50 dry weight %; and cellulose may be present in an amount ranging between about 10 dry weight % and about 60 dry weight %. It is to be understood that the gelatin and the polyvinyl alcohol may be present in the adhesion promoting layer 20 in an amount ranging between about 45 dry weight % and about 55 dry weight %, such that the total dry weight % is about 100%. In an another embodiment, the amount of gelatin in the adhesion promoting layer 20 ranges from about 40 dry weight % to about 100 dry weight %.

Referring now to FIG. 1C, a first ink-receiving layer 22 is established on the adhesion promoting layer 20. The first ink-receiving layer 22 may be designed to provide a high degree of “capacity” (e.g. ink-retention capability) in connection with the photo medium system 10 to facilitate rapid absorption of ink vehicles and therefore rapid drying of the printed image, to form a smooth/even surface, and/or to otherwise help to ensure that the desired gloss characteristics and image permanence are substantially maintained in the finished product. In order to achieve these goals, the first ink-receiving layer 22 has a binder composition that includes polyvinyl alcohol (PVOH), modified polyvinyl alcohol, and gelatin.

In a non-limitative example, the PVOH may be present in the first ink-receiving layer 22 in an amount ranging from about 40 dry weight % to about 80 dry weight %. One suitable non-limitative example of a polyvinyl alcohol is commercially available under the tradename MOWIOL 26-88 from Clariant, located in Muttenz, Switzerland.

The modified polyvinyl alcohol may be present in the first ink-receiving layer 22 in an amount ranging from about 5 dry weight % to about 20 dry weight %. A non-limitative example of modified polyvinyl alcohol includes a hydrophilic group modified polyvinyl alcohol, which is commercially available under the tradename WO320R from Nippon Gohsei located in Japan. Some other non-limitative examples of suitable modified polyvinyl alcohols are a copolymer of polyvinyl alcohol and polyethylene oxide, acetoacetylated polyvinyl alcohols commercially available under the tradenames GOHSEFIMER Z-100, GOHSEFIMER Z-200, GOHSEFIMER Z-210 and GOHSEFIMER Z-320 from Nippon Gohsei located in Japan, and partially hydrolyzed polyvinyl alcohols commercially available under the tradenames AIRVOL 523 and AIRVOL 540 from Air Product and Chemicals, Inc. located in Allentown, Pa. and MOWIOL 18-88, 23-88, 40-88, or 47-88 from Clariant located in Muttenz, Switzerland.

Finally, the gelatin may be present in the first ink-receiving layer 22 in an amount ranging from about 20 dry weight % to about 60 dry weight %. It is to be understood that the materials (PVOH, modified PVOH, and gelatin) may be included in a desired amount as described such that the total dry weight % of the first ink-receiving layer 22 is about 100%.

The first ink-receiving layer 22 may have a representative and non-limiting uniform thickness T₁ along substantially its entire length ranging between about 2 μm and about 20 μm, although this range may be varied as desired.

Referring now to FIG. 1D, a second ink-receiving layer 24 is established on the first ink-receiving layer 22. The second ink-receiving layer 24 has a binder composition that includes polyvinyl alcohol, gelatin, and styrene-acrylic copolymers. It is to be understood that the second ink-receiving layer 24 generally enhances the “capacity” (e.g. ink-retention capability) in connection with the photo medium system 10 to facilitate rapid absorption of ink vehicles and therefore rapid drying of the printed image and enhancing humid fastness, to form a smooth/even surface, and/or to otherwise help to ensure that the desired gloss characteristics and image permanence are substantially maintained in the finished product.

In a non-limitative example, the second ink-receiving layer 24 includes about 25 dry weight % to about 55 dry weight % of the polyvinyl alcohol; about 40 dry weight % to about 75 dry weight % of the gelatin; and about 5 dry weight % to about 30 dry weight % of the styrene-acrylic copolymers. In an alternate embodiment, the polyvinyl alcohol ranges from about 20 dry weight % to about 40 dry weight % and the gelatin ranges from about 40 dry weight % to about 60 dry weight %.

Non-limitative examples of suitable styrene-acrylic copolymers include poly(styrene)-(methyl-2-(acryloyloxy)ethylammonium salts), poly(styrene)-(ethyl-2-(acryloyloxy) ethylammonium salts), poly(styrene)-(methyl-3-(acryloyloxy)propylammonium salts), poly(styrene)-(n-butyl acrylate)-(methyl methacrylate)-(2-(tert-butylamino)ethyl methacrylate), poly(styrene)-(ethyl-2-(acryloyoxy)propylammonium salts), and/or combinations thereof.

It is to be understood that the materials (PVOH, gelatin, and styrene-acrylic copolymers) may be included in a desired amount as described, such that the total dry weight % of the second ink-receiving layer 24 is about 100%.

The second ink-receiving layer 24 may have a representative and non-limiting uniform thickness T₂ along substantially its entire length ranging between about 1 μm and about 10 μm, although this range may be varied as desired.

Referring now to FIG. 1E, the image enhancing layer 26 includes modified polyvinyl alcohol, styrene-acrylic copolymers, and cationic polyurethanes. The image enhancing layer 26 advantageously enhances the quality and permanence of the printed image. Without being bound to any theory, it is believed that the addition of cationic polyurethanes advantageously enhances the black haze and the gloss of the medium to which they are applied. Cationic polyurethanes are generally compounded polyurethane copolymers. A non-limitative example of a cationic polyurethane material is commercially available under the tradename PATELACOL IJ-26 from Dainippon Ink and Chemicals/Dainippon International (USA), Inc. located in Fort Lee, N.J.

In an embodiment, the image enhancing layer 26 includes about 50 dry weight % to about 80 dry weight % of the modified polyvinyl alcohol, about 1 dry weight % to about 20 dry weight % of the cationic polyurethanes, and about 10 dry weight % to about 30 dry weight % of the styrene-acrylic copolymers.

It is to be understood that the materials (modified PVOH, cationic polyurethanes, and styrene-acrylic copolymers) may be included in a desired amount as described, such that the total dry weight % of the image enhancing layer 26 is about 100%.

The image enhancing layer 26 may have a representative and non-limiting uniform thickness T₃ along substantially its entire length ranging between about 0.5 μm and about 5 μm, although this range may be varied as desired.

It is to be understood that other ingredients may also be incorporated within the ink-receiving layers 22, 24, and the image enhancing layer 26 in variable quantities. These other ingredients include but are not limited to crosslinking compounds (non-limitative examples include borates, titanium salts, melamine-formaldehyde which is commercially available under the tradename MADURIT MW from Vianova Resins GmbH located in Mainz, Germany, glyoxals, thiourea-formaldehydes, and commercially available CURESAN from BASF Corp. located in Mount Olive, N.J., and mixtures thereof), fillers, surfactants, light-stabilizers, preservatives (e.g. antioxidants), general stabilizers, and/or the like, and/or mixtures thereof. The quantity of the additional components may range between about 0.1% and about 1% of the total layer(s) 22, 24, 26. In a further embodiment, the quantity of the additional components may range between about 0.2% and about 0.3% of the total layer(s) 22, 24, 26.

It is to be understood that, if a crosslinking compound is included in the ink-receiving layer(s) 22, 24 and/or the image enhancing layer 26, adding too much of the crosslinking compound may result in a decrease in capacity, potentially causing coalescence in the layer(s) 22, 24, 26; while adding too little crosslinking compound may result in weak binding power, potentially causing the layer(s) 22, 24, 26 to have relatively low resistance. While these additional components may be contained within the layer(s) 22, 24, 26, they are considered optional and may be employed as desire.

Embodiments of the system 10 and composition 11 advantageously provide many advantages, including, but not limited to the following. Without being bound to any theory, it is believed that the combination of the different ink-receiving layers 22, 24 and the image enhancing layer 26 advantageously provide substantially enhanced black haze, substantial gloss uniformity, enhanced color gamut, enhanced image distinctness, and/or enhanced feed reliability. Still further, the image printed on the photo medium composition 11 has a relatively short drying time (e.g. about 24 hours), such that after that time, the photo medium will not substantially stick to plastic album sheets or frames.

While several embodiments have been described in detail, it will be apparent to those skilled in the art that the disclosed embodiments may be modified. Therefore, the foregoing description is to be considered exemplary rather than limiting.

1. A photo medium composition, comprising:
an adhesion promoting layer;
at least two ink-receiving layers established on the adhesion promoting layer, each of the at least two ink-receiving layers comprising a polymeric binder composition including at least one of polyvinyl alcohol, modified polyvinyl alcohol, or combinations thereof, and including at least one of styrene-acrylic copolymers, gelatin, or combinations thereof; and
an image enhancing layer established on the at least two ink-receiving layers, the image enhancing layer including cationic polyurethanes.

2. The photo medium composition as defined in claim 1 wherein each of the at least two ink-receiving layers has a different polymeric binder composition from an other of the at least two ink-receiving layers.

3. The photo medium composition as defined in claim 1 wherein the adhesion promoting layer is selected from gelatin, polyvinyl alcohol, polyurethanes, cellulose, and combinations thereof.

4. The photo medium composition as defined in claim 1 wherein: a first layer of the at least two ink-receiving layers is established on the adhesion promoting layer, and includes polyvinyl alcohol, modified polyvinyl alcohol, and gelatin; a second layer of the at least two ink-receiving layers is established on the first layer, and includes polyvinyl alcohol, gelatin, and styrene-acrylic copolymers; and the image enhancing layer is established on the second layer, and includes modified polyvinyl alcohol, styrene-acrylic copolymers, and the cationic polyurethanes.

5. The photo medium composition as defined in claim 4 wherein the polyvinyl alcohol is present in the first layer in an amount ranging from about 40 dry weight % to about 80 dry weight %, wherein the modified polyvinyl alcohol is present in the first layer in an amount ranging from about 5 dry weight % to about 20 dry weight %, and wherein the gelatin is present in the first layer in an amount ranging from about 20 dry weight % to about 60 dry weight %.

6. The photo medium composition as defined in claim 5 wherein the first layer has a thickness ranging from about 2 μm to about 20 μm.

7. The photo medium composition as defined in claim 4 wherein the polyvinyl alcohol is present in the second layer in an amount ranging from about 20 dry weight % to about 40 dry weight %, wherein the gelatin is present in the second layer in an amount ranging from about 40 dry weight % to about 60 dry weight %, and wherein the styrene-acrylic copolymers are present in the second layer in an amount ranging from about 5 dry weight % to about 30 dry weight %.

8. The photo medium composition as defined in claim 7 wherein the second layer has a thickness ranging from about 1 μm to about 10 μm.

9. The photo medium composition as defined in claim 4 wherein the image enhancing layer includes from about 50 dry weight % to about 80 dry weight % of modified polyvinyl alcohol, from about 1 dry weight % to about 20 dry weight % of the cationic polyurethanes, and from about 10 dry weight % to about 30 dry weight % of the styrene-acrylic copolymers.

10. The photo medium composition as defined in claim 1 wherein the styrene-acrylic copolymers are selected from poly(styrene)-(methyl-2-(acryloyloxy) ethylammonium salts), poly(styrene)-(ethyl-2-(acryloyloxy)ethylammonium salts), poly(styrene)-(methyl-3-(acryloyloxy) propylammonium salts), poly(styrene)-(n-butyl acrylate)-(methyl methacrylate)(2-(tert-butylamino)ethyl methacrylate), poly(styrene)-(ethyl-2-(acryloyoxy)propylammonium salts), and combinations thereof.

11. The photo medium composition as defined in claim 1 wherein the modified polyvinyl alcohol is a copolymer of polyvinyl alcohol and polyethylene oxide.

12. The photo medium composition as defined in claim 1 wherein a first of the at least two ink-receiving layers has a thickness ranging from about 2 μm to about 20 μm, and wherein a second of the at least two ink-receiving layers has a thickness ranging from about 1 μm to about 10 μm.

13. The photo medium composition as defined in claim 1 wherein the image enhancing layer has a thickness ranging from about 0.5 μm to about 5 μm.

14. A photo medium system, comprising:
a substrate;
an adhesion promoting layer established on the substrate;
at least two Ink-receiving layers established on the adhesion promoting layer, each of the at least two ink-receiving layers comprising a polymeric binder composition including at least one of polyvinyl alcohol, modified polyvinyl alcohol, or combinations thereof, and including at least one of styrene-acrylic copolymers, gelatin, or combinations thereof; and
an image enhancing layer established on the at least two ink-receiving layers, the image enhancing layer including cationic polyurethanes.

15. The photo medium system as defined in claim 14 wherein each of the at least two ink-receiving layers has a different polymeric binder composition from an other of the at least two ink-receiving layers.

16. The photo medium system as defined in claim 14 wherein the substrate is selected from papers, polymeric materials, metals, photopaper, and mixtures thereof.

17. The photo medium system as defined in claim 14 wherein the adhesion promoting layer is selected from gelatin, polyvinyl alcohol, polyurethanes, cellulose, and combinations thereof.

18. The photo medium system as defined in claim 14 wherein: a first layer of the at least two ink-receiving layers is established on the adhesion promoting layer, and includes polyvinyl alcohol, modified polyvinyl alcohol, and gelatin; a second layer of the at least two ink-receiving layers is established on the first layer, and includes polyvinyl alcohol, gelatin, and styrene-acrylic copolymers; and the image enhancing layer is established on the second layer, and includes modified polyvinyl alcohol, styrene-acrylic copolymers, and cationic polyurethanes.

19. The photo medium system as defined in claim 18 wherein the polyvinyl alcohol is present in the first layer in an amount ranging from about 40 dry weight % to about 80 dry weight %, wherein the modified polyvinyl alcohol is present in the first layer in an amount ranging from about 5 dry weight % to about 20 dry weight %, and wherein the gelatin is present in the first layer in an amount ranging from about 20 dry weight % to about 60 dry weight %.

20. The photo medium system as defined in claim 18 wherein the polyvinyl alcohol is present in the second layer in an amount ranging from about 25 dry weight % to about 55 dry weight %, wherein the gelatin is present in the second layer in an amount ranging from about 40 dry weight % to about 75 dry weight %, and wherein the styrene-acrylic copolymers are present in the second layer in an amount ranging from about 5 dry weight % to about 30 dry weight %.

21. The photo medium system as defined in claim 18 wherein the image enhancing layer includes from about 50 dry weight % to about 80 dry weight % of modified polyvinyl alcohol, from about 1 dry weight % to about 20 dry weight % of the cationic polyurethanes, and from about 10 dry weight % to about 30 dry weight % of the styrene-acrylic copolymers.

22. The photo medium system as defined in claim 14 wherein the styrene-acrylic copolymers are selected from poly(styrene)-(methyl-2-(acryloyloxy)ethylammonium salts), poly(styrene)-(ethyl-2-(acryloyloxy)ethylammonium salts), poly(styrene)(methyl-3(acryloyloxy)propylammonium salts), poly(styrene)-(n-butyl acrylate)-(methyl methacrylate)-(2-(tert-butylamino)ethyl methacrylate), poly(styrene)-(ethyl-2-(acryloyoxy) propylammonium salts), and combinations thereof.

23. The photo medium system as defined in claim 14 wherein the modified polyvinyl alcohol is a copolymer of polyvinyl alcohol, a copolymer of polyethylene oxide, and mixtures thereof.

24. The photo medium system as defined in claim 14 wherein a first of the at least two ink-receiving layers has a thickness ranging from about 2 μm to about 20 μm, and wherein a second of the at least two ink-receiving layers has a thickness ranging from about 1 μm to about 10 μm.

25. The photo medium system as defined in claim 14 wherein the image enhancing layer has a thickness ranging from about 0.5 μm to about 5 μm.

26. A method of making a photo medium system, the method comprising:
establishing an adhesion promoting layer on a substrate;
establishing a first ink-receiving layer on the adhesion promoting layer, the first ink-receiving layer including polyvinyl alcohol, modified polyvinyl alcohol, and gelatin;
establishing a second ink-receiving layer on the first ink-receiving layer, the second ink-receiving layer including polyvinyl alcohol, gelatin, and styrene-acrylic copolymers; and
establishing an image enhancing layer on the second ink-receiving layer, the image enhancing layer including modified polyvinyl alcohol, cationic polyurethanes, and styrene-acrylic copolymers.

27. The method as defined in claim 26 wherein the establishing steps are accomplished by at least one of roll-coating, slot-die processing, blade coating, slot-die cascade coating, curtain coating, or combinations thereof.

28. The method as defined in claim 26 wherein the substrate is selected from papers, polymeric materials, metals, photopaper, and mixtures thereof.

29. The method as defined in claim 26 wherein the adhesion, promoting layer is selected from gelatin, polyvinyl alcohol, polyurethanes, cellulose, and combinations thereof.

30. The method as defined in claim 26 wherein the first ink-receiving layer comprises the polyvinyl alcohol in an amount ranging from about 40 dry weight % to about 80 dry weight %, the modified polyvinyl alcohol in an amount ranging from about 5 dry weight % to about 20 dry weight %, and the gelatin in an amount ranging from about 20 dry weight % to about 60 dry weight %.

31. The method as defined in claim 30 wherein the first ink-receiving layer is established having a thickness ranging from about 2 μm to about 20 μm.

32. The method as defined in claim 26 wherein the second ink-receiving layer comprises the polyvinyl alcohol in an amount ranging from about 25 dry weight % to about 55 dry weight %, the gelatin in an amount ranging from about 40 dry weight % to about 75 dry weight %, and the styrene-acrylic copolymers in an amount ranging from about 5 dry weight % to about 30 dry weight %.

33. The method as defined in claim 32 wherein the second ink-receiving layer is established having a thickness ranging from about 1 μm to about 10 μm.

34. The method as defined in claim 26 wherein the image enhancing layer comprises the modified polyvinyl alcohol in an amount ranging from about 50 dry weight % to about 80 dry weight %, the cationic polyurethanes in an amount ranging from about 1 dry weight % to about 20 dry weight %, and the styrene-acrylic copolymers in an amount ranging from about 10 dry weight % to about 30 dry weight %.

35. The method as defined in claim 34 wherein the image enhancing layer is established having a thickness ranging from about 0.5 μm to about 5 μm.

36. The method as defined in claim 26 wherein the styrene-acrylic copolymers are selected from poly(styrene)-(methyl-2-(acryloyloxy)ethylammonium salts) poly(styrene)-(ethyl-2-(acryloyloxy)ethylammonium salts), poly(styrene)-(methyl-3-(acryloyloxy) propylammonium salts), poly(styrene)-(n-butyl acrylate)-(methyl methacrylate)-(2-(tert-butylamino)ethyl methacrylate), poly(styrene)-(ethyl-2-(acryloyoxy)propylammonium salts), and combinations thereof.

37. The method as defined in claim 26 wherein the modified polyvinyl alcohol is a copolymer of polyvinyl alcohol and polyethylene oxide.

38. A method of making a photo medium system, comprising the step of:
depositing a photo medium composition on a substrate, the photo medium composition comprising:
an adhesion promoting layer;
at least two ink-receiving layers established on the adhesion promoting layer, each of the at least two ink-receiving layers comprising a polymeric binder composition including at least one of polyvinyl alcohol, modified polyvinyl alcohol, or combinations thereof, and including at least one of styrene-acrylic copolymers, gelatin, or combinations thereof; and
an image enhancing layer established on the at least two ink-receiving layers, the image enhancing layer including cationic polyurethanes.

39. The method as defined in 38 wherein the depositing is accomplished by at least one of roll-coating, slot-die processing, blade coating, slot-die cascade coating, curtain coating, or combinations thereof.
